(19) United States
(12) Patent Application Publication
(10) Pub. No.: US 2007/0197328 A1
(43) Pub. Date: Aug. 23, 2007

(54) Toothed plate-link chain

(75) Inventors: Marcus Junig, Buhlertal (DE); Anton Simonov, Buhl (DE); Olga Ispolatova, Buhl (DE); Michael Pichura, Buhl (DE); Martin Vornehm, Buhl (DE); Aurel Vietoris, Buhl (DE)

Correspondence Address: ALFRED J MANGELS, 4729 CORNELL ROAD, CINCINNATI, OH, 452412433, US

(73) Assignee: Luk Lamellen und Kupplungsbau Beteiligungs KG, Buhl (DE)

(21) Appl. No.: 11/645,151

(22) Filed: Dec. 23, 2006

Related U.S. Application Data
(60) Provisional application No. 60/753,765, filed on Dec. 23, 2005.

(51) Int. Cl. F16G 13/04

(52) U.S. Cl. 474/213; 474/215

(57) ABSTRACT

A toothed plate-link chain including plate sets of toothed plates as well as at least one guide plate. The guide plate which is positioned within a plate set, or as a lateral end plate, and is carried on two chain pins that pass through openings in the guide plate as well as opening in the toothed plates. The guide plate has a wing that in the running direction, or opposite to the running direction, of the toothed plate-link chain extends beyond a plate tooth of a toothed plate in the same plate set.

### BACKGROUND OF THE INVENTION

1. Field of the Invention

The present invention relates to a toothed plate-link chain including plate sets of toothed plates, as well as at least one guide plate that is positioned in the plate set or as a lateral end plate and on two plate connection pins.

2. Description of the Related Art

Guide plates are needed in toothed plate-link chains order to be able to guide such a chain to an exact position on a toothed wheel. Such guide plates can be designed as inner (single) or outer (double) guide plates. Outer guide plates are generally used, because that eliminates the need for additional processing of the toothed wheel, namely placing an annular groove at the location where the guide plate is supposed to engage with the toothed wheel. Guiding of the chain with the outer guide plates is achieved by overlapping the guide plates with the front sides of the sprocket wheel teeth. A guide plate is an additional plate in an existing toothed plate set.

In guide plates in accordance with the existing practice, the front tooth of a toothed link plate hurries on ahead, viewed in the running direction of the chain, so it lacks leading guidance.

An object of the present invention is therefore to provide a toothed plate-link chain in which the toothed plate links have leading guidance.

### SUMMARY OF THE INVENTION

That object of the invention is achieved by providing a toothed plate-link chain including plate sets of toothed plates and at least one guide plate that is positioned inside the plate set or is arranged as a lateral end plate on two chain pins. The guide plate has a wing that extends beyond a tooth of a toothed plate in the same plate set in the running direction, or opposite to the running direction, of the toothed plate-link chain. With a toothed plate-link chain of that type, the wing of the guide plate reaches a toothed wheel before the front tooth of the toothed plate, as viewed in the running direction of the chain. Thus, leading guidance of each individual tooth is effected.

A refinement of the invention includes the provision that the guide plate has two wings, each of which extends past a tooth in the same plate set in the running direction of, or opposite to the running direction of, the toothed plate-link chain. In particular, in the case of toothed plate-link chains that are operated with running direction changes, that enables the advantages of the leading guidance of the wing in accordance with the invention to be used in both running directions. A recess in the form of a space free of material remains between the wings, so that the advantage of material saving compared to a continuous wing remains.

A refinement of the invention provides that the wings are inclined on their ends facing a wing of an adjacent guide plate, which leaves a gap to a corresponding inclination of the ends of the adjacent guide plate when the adjacent guide plate pivots. Such an arrangement ensures that the wings of adjacent guide plates do not touch as the chain bends. When the ends do touch, the gap between the two completely disappears and the smallest possible bend diameter of the toothed plate-link chain is reached.

Preferably, it is provided that the wings are inclined on an end facing a wing of an adjacent guide plate, which at least partially closes a gap with a corresponding inclination of the end of the adjacent guide plate when the adjacent guide plate pivots. If the gap is almost completely closed, optimal leading guidance is achieved, since maximum permissible overlapping of the wing with the corresponding tooth of the toothed wheel is achieved without two adjacent wings of two adjacent guide plates touching.

A refinement of the invention includes the provision that the wings have a curve on their ends facing a wing of an adjacent guide plate, which leaves a gap to a corresponding curve of the ends of an adjacent guide plate when the adjacent guide plate pivots. With such an arrangement, providing a curve instead of an inclination with a straight line, the curve can be positioned at an optimal location in regard to the overlap with the tooth of a toothed wheel when the chain bends.

A preferred embodiment of the toothed plate-link chain in accordance with the invention includes the provision -that the guide plate has a waist between its attachments to the chain pins. The waist reduces the spring constant as the guide plate is extended, compared to a non-waisted guide plate. That also reduces the surface pressure on the attaching pin with which the guide plate is integrated into the chain set. The stretching force exerted on the guide plate during extension of the toothed plate-link chains is thereby reduced.

Preferably, provision is made for the waist to have a height that is smaller than the height of the toothed plates. That enables an especially distinctive shape of the waist.

It can also be provided in the toothed plate-link chain for the further plate sets to include toothless opposed plates, with the sets of toothed plates and the sets of opposed toothless plates arranged alternately in the running direction of the chain. That provides an alternative design for a toothed plate-link chain, in which the teeth of leading and trailing plate sets no longer overlap.

The object identified earlier is also achieved by a guide plate for a toothed plate-link chain in accordance with the invention having the features identified in connection with the guide plate, as well as a transmission and a motor vehicle, in particular a motor vehicle having a toothed plate-link chain in accordance with the invention.

### BRIEF DESCRIPTION OF THE DRAWINGS

The structure, operation, and advantages of the present invention will become further apparent upon consideration of the following description, taken in conjunction with the accompanying drawings in which:

FIG. 1 is a side view of a portion of a known plate link chain;

FIG. 2 is a top view of a portion of a known plate link chain;

FIG. 3 is a side view of a first exemplary embodiment of a guide plate in accordance with the invention;

FIG. 4 shows a distribution of the guide plates as stamped parts on a stamping sheet;

FIG. 5 is a side view of a section of an extended plate-link chain with guide plates in accordance with FIG. 4;

FIG. 6 is a side view of a section of a bent plate-link chain with guide plates in accordance with FIG. 4;

FIG. 7 is a side view of a second exemplary embodiment of a guide plate in accordance with the invention;

FIG. 8 is a side view of a section of an extended plate-link chain with guide plates in accordance with FIG. 7;

FIG. 9 is a side view of a section of a bent plate-link chain with guide plates in accordance with FIG. 7;

FIG. 10 is a side view of a third exemplary embodiment of a guide plate in accordance with the invention;

FIG. 11 is a side view of a section of an extended plate-link chain with guide plates in accordance with FIG. 10;

FIG. 12 is a side view of a section of a bent plate-link chain with guide plates in accordance with FIG. 10.

### DESCRIPTION OF THE PREFERRED EMBODIMENTS

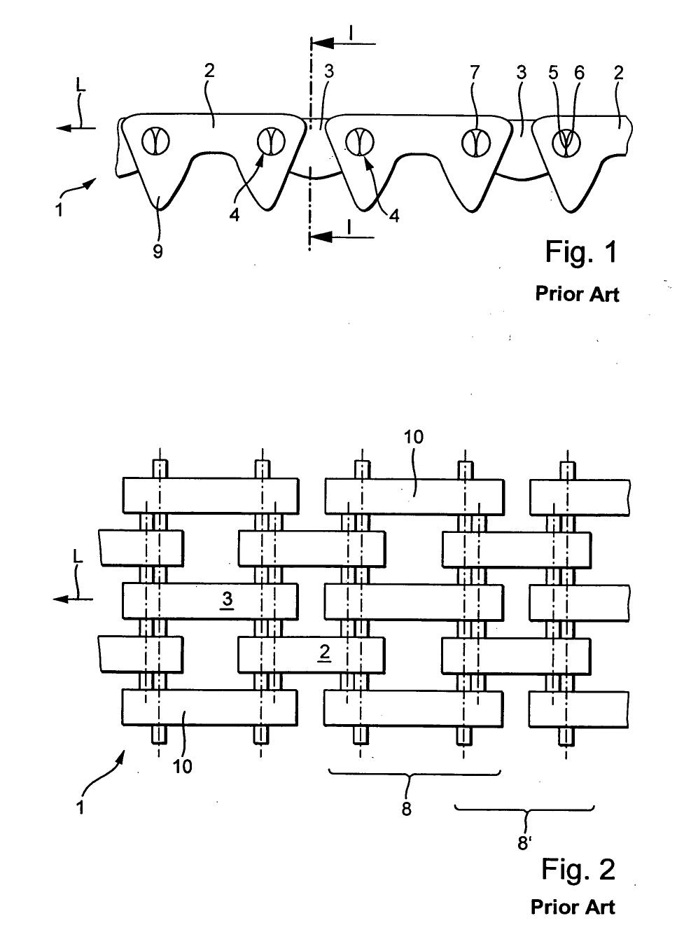

FIG. 1 shows by way of example a side view, and FIG. 2 a top view, of a plate-link chain in accordance with the existing art, having a two-plate connection. The basic construction of plate-link chains and the terms used in the exemplary embodiments in accordance with the invention will be explained on the basis of FIGS. 1 and 2. The exemplary embodiments will be described using the example of a plate-link chain having a two-plate connection, but are equally applicable to a plate-link chain having a three-plate connection.

Plate-link chain 1 includes a large number of plates 2 and opposed plates 3. Plates 2 and opposed plates 3 are arranged alternately across the width of the chain, as shown in FIG. 2, and are connected by joint pins 4 as a link. Consequently, both ends of a plate are connected to one or two opposed plates by means of a joint pin, and, correspondingly, both ends of an opposed plate are connected to one or two plates with a joint. The joint pins 4 can be in one piece, but are preferably in two pieces, whereby a rocker member 5 is arranged in each of the plates and rolls against a rocker member 6 arranged in the opposed plate 2. In addition, rocker members 5, 6 each have a roller profile 7 and 7′, respectively, with which they can roll or slide on each other. The roller profiles 7, 7′ can be identical or different.

The plates 2 and opposed plates 3′ are stacked transversely to the chain running direction indicated by arrow L, so that an overlapping opposed plate is positioned between two joint pins 4 that are arranged side-by-side perpendicular to the running direction L, and conversely a plate is positioned between and overlaps two opposed plates that are side-by-side transversely relative to the running direction. Of course, that does not apply to the plates 2 or opposed plates 3 that are located on the outside and transversely to the running direction 2; those have a neighbor on only one side. The sets of plates 2 formed in that way form a chain link 8 by sets; correspondingly, the opposed sets of opposed plates 3′ form a chain link 8′ by sets.

In the present exemplary embodiment the plates 2 and opposed plates 3 can be identical parts, a differentiation between plates 2 and opposed plates 3 being recognizable only by their arrangement. The following discussion will therefore refer only to plates 2, because those are identical to the opposed plates except for the arrangement in sets. FIG. 2 shows a transverse stack of two plates 2 and three opposed plates 3; but it is also possible to provide stacks with any other number of plates 2 and opposed plates 3.

The plates 2 are each provided with plate teeth 9, as can be seen in FIG. 1. With the plate teeth 9, plate link chain 1 can mesh with a toothed part, for example a gear. The spacing between plates 2 and opposed plates 3 is designed so that when the chain is extended a uniform spacing results overall between plate teeth 9. Alternatively, the opposed plates 3 can also be provided with plate teeth 9, so that all plates and opposed plates are provided with plate teeth. But it is equally possible to provide plates and opposed plates with only one plate tooth 9.

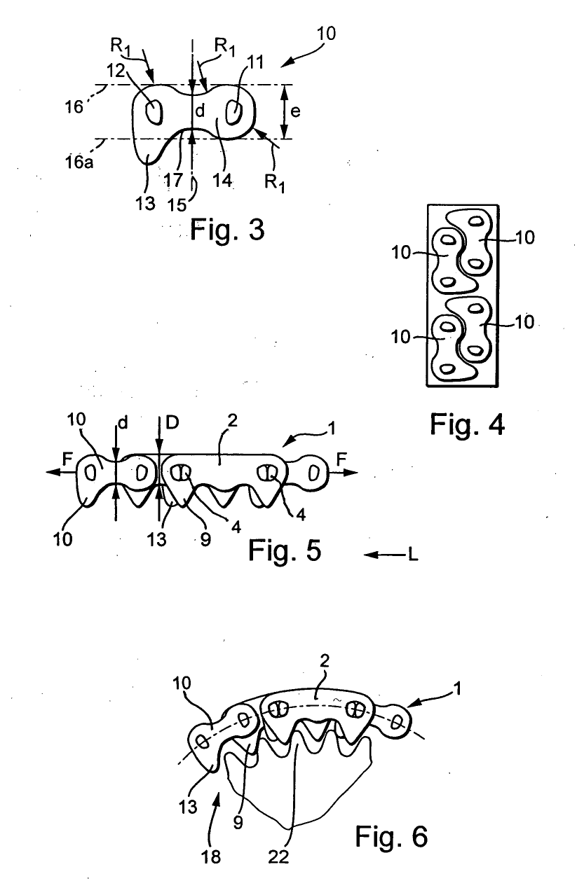

FIG. 3 shows a first exemplary embodiment of a guide plate 10 in accordance with the present invention. Guide plate 10 includes two openings 11 and 12, with which the plate can be connected with the chain pins 4. In the exemplary embodiment in FIG. 3 openings 11 and 12 are designed so that they correspond in cross section to that of the rocker members 5, 6, to which the plate set belonging to the respective chain link 8, 8′ is connected. Guide plate 10 includes a wing 13. Wing 13 is positioned on guide plate 10 in such a way that it is on the same side of plate-link chain 1 as the plate teeth 9 when guide plate 10 is in its installed position within plate-link chain 1. Wing 13 extends beyond a main body 14, which is otherwise substantially symmetrical relative to an axis of symmetry 15.

In the region of opening 11, guide plate 10 has a height e. Between the two openings 11, 12, guide plate 10 has a height of d, the height d being smaller than the height e. So guide plate 10 is narrowed between openings 11, 12 and has a waist 17 therebetween. If one places a straight line 16 along the upper surfaces of guide plate 10, i.e., on the edges facing away from wing 13, and in the region of the openings, and places on the lower surface, i.e., the surface along the edge on which wing 13 is positioned, a parallel straight line 16a that touches the guide plate in the region of height e, wing 13 projects beyond that pair of straight lines 16, 16a that enclose the main body 14.

Main body 14 has a circular outside contour with radii RI, both in the region of the waist 17 and in the outer edges at the regions of the two openings 11 and 12, with the radii RI being identical. That permits the optimal distribution of the guide plate as a stamped part on a stamping sheet, as shown in FIG. 4.

FIG. 5 shows a side view of a portion of a plate-link chain 1 including guide plates 10 in accordance with the invention. Toothed plates 2 have a minimum height D in the region between the plate teeth 9 and between the pins 4. The minimum height d of guide plates 10 in that region is smaller than the minimum height D of the toothed plates. If a tensile force F is applied to plate-link chain 1, the resulting surface pressure of the edges of openings 11, 12 on the corresponding pins, or rocker members, is low, because guide plate 10 itself has only low stiffness because of the comparatively small cross section in the region of the waist 17 compared to the cross section of the toothed plates.

As can also be seen in FIG. 5, the wings 13 jut out relative to the running direction L of plate-link chain 1, which is identified by an arrow with the letter L in FIG. 5. Thus, the profile of the wings 13 overhangs the profile of the plate teeth 9. In chain running direction L, the wings 13 precede the plate teeth 9. Before a plate tooth 9 meshes with a toothed wheel 18, shown in FIG. 6, the wings 13 that belong to the guide plates of the particular plate set will already have reached it. That process is shown in FIG. 6. As can be seen, the wings 13 precede the plate teeth 9 and overlap the sides of teeth 22 of the toothed wheel 18.

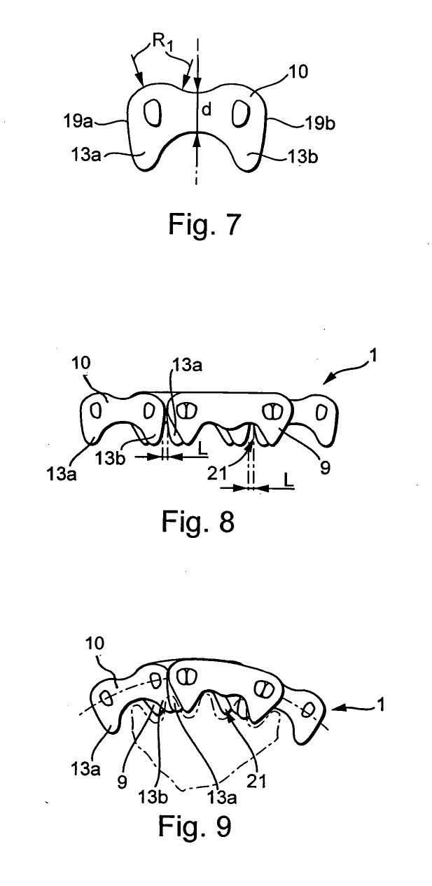

FIGS. 7 through 9 show an alternative exemplary embodiment of a guide plate 10. In contrast to the exemplary embodiments in FIGS. 3 through 6, instead of one wing 13, there are provided a front wing 13a and a rear wing 13b. Otherwise the exemplary embodiment in FIG. 7 corresponds substantially to the exemplary embodiment in FIG. 3.

In contrast to the exemplary embodiment in accordance with FIG. 3, however, wings 13a and 13b have inclined outer sides 19a and 19b. The inclinations are formed as straight sections. The function of the inclinations 19a, 19b can be seen from the illustrations in FIGS. 8 and 9. FIG. 8 shows the chain 1 extended; FIG. 9 shows the chain 1 bent or bowed when encircling a toothed wheel 18. In the extended chain in accordance with FIG. 8, the teeth 13a, 13b of two guide plates 10 in sequential order have a minimum separation L in the chain running direction, so that there is a gap 21 of triangular shape, increasing in size toward the inside. With the bent plate-link chain in accordance with FIG. 9, the inclined edges 19a, 19b of two guide plates 10 in sequential order touch, so that the gap 20 between the two nearly or completely disappears.

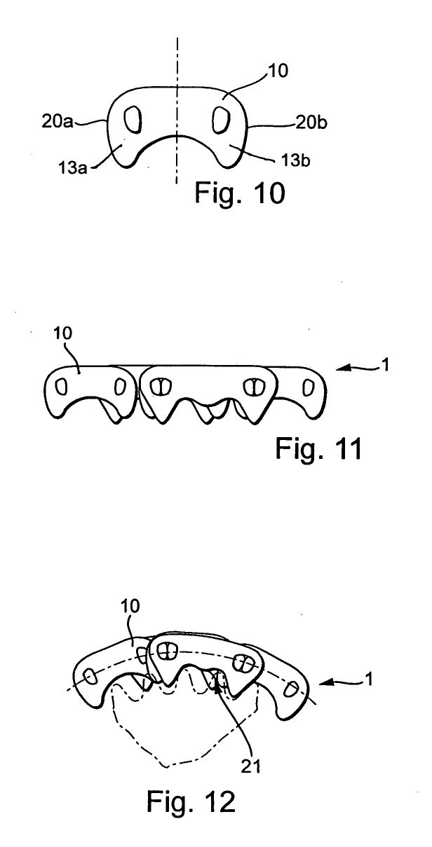

FIGS. 10 through 12 show another exemplary embodiment of a guide plate in accordance with the invention. That exemplary embodiment is substantially the same as that in FIGS. 7 through 9, but in contrast the inclined edges 19a and 19b of the FIGS. 7 through 9 embodiment take the form of curved edges 20a and 20b. Here too, the wings 1 3a and 1 3b in particular the curved edges 20a and 20b—as can be seen in FIG. 12—are designed so that adjacent wings of adjacent guide plates do not touch. The exemplary embodiment in FIGS. 10 through 12 is shown without a waist 17, but it can also be provided in that exemplary embodiment.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A toothed plate-link chain comprising: a plurality of plate sets composed of toothed plates, at least one guide plate positioned on two chain pins and in association with a plate set containing toothed plates, wherein the guide plate includes at least one wing that extends transversely to the longitudinal direction of the chain and extend beyond a tooth of a toothed plate of the associated plate set in the longitudinal direction of the chain.

2. A toothed plate-link chain in accordance with claim 1, wherein the guide plate includes two wings that in the longitudinal direction of the chain each extend beyond a tooth of a toothed plate in the same plate set.

3. A toothed plate-link chain in accordance with claim 2, wherein on their ends facing a wing of an adjacent guide plate the wings each have an inclined edge that defines a gap with a correspondingly-inclined end of an adjacent guide plate to allow relative pivoting of the adjacent guide plates without interference when the chain bends.

4. A toothed plate-link chain in accordance with claim 3, wherein the inclinations of the edges of adjacent guide plates are sufficient to at least partially close the gap with the corresponding-inclined edge of the adjacent guide plate when the adjacent guide plates pivot relative to each other.

5. A toothed plate-link chain in accordance with claim 1, wherein ends of the wings that face a wing of an adjacent guide plate are curved to provide a gap between adjacent guide plates when the adjacent guide plates pivot relative to each other.

6. A toothed plate-link chain in accordance with claim 1, wherein the guide plate has a waist portion between chain-pin-receiving openings in the guide plate.

7. A toothed plate-link chain in accordance with claim 5, wherein the waist has a height in a direction perpendicular to the chain longitudinal direction that is smaller than a height at longitudinal ends of the toothed plates.

8. A toothed plate-link chain in accordance with claim 1, wherein the chain includes plate sets of toothless opposed plates, with plate sets of toothed plates and the plate sets of toothless opposed plates arranged alternately in the longitudinal direction of the chain.

9. A guide plate for a toothed plate-link chain, said guide plate comprising: a plate body including a pair spaced openings for receiving chain pins, and at least one wing that projects outwardly from the plate body in a transverse direction to the longitudinal direction of the guide plate

10. A transmission including a toothed plate-link chain for transmitting torque between an input and an output, said chain comprising: a plurality of plate sets composed of toothed plates, at least one guide plate positioned on two chain pins and in association with a plate set containing toothed plates, wherein the guide plate includes at least one wing that extends transversely to the longitudinal direction of the chain and extend beyond a tooth of a toothed plate of the associated plate set in the longitudinal direction of the chain.

11. A motor vehicle having a transmission with a toothed plate-link chain, said chain comprising: a plurality of plate sets composed of toothed plates, at least one guide plate positioned on two chain pins and in association with a plate set containing toothed plates, wherein the guide plate includes at least one wing that extends transversely to the longitudinal direction of the chain and extend beyond a tooth of a toothed plate of the associated plate set in the longitudinal direction of the chain.

12. A toothed plate-link chain in accordance with claim 1, wherein the guide plate is positioned inside a plate set.

13. A toothed plate-link chain in accordance with claim 1, wherein the guide plate is a laterally outer end plate of a plate set.
